(19) United States
(12) Patent Application Publication
(10) Pub. No.: US 2011/0282780 A1
(43) Pub. Date: Nov. 17, 2011

(54) METHOD AND SYSTEM FOR DETERMINING FEES AND FOREIGN EXCHANGE RATES FOR A VALUE TRANSFER TRANSACTION

(76) Inventors: Susan French, Foster City, CA (US); Mark Carlson, Half Moon Bay, CA (US); Alesia Panagiotides, San Mateo, CA (US); Justin Chace, Redwood City, CA (US); Kate Kennedy, Roseville, CA (US); Ashwin Raj, Foster City, CA (US); John Tullis, San Francisco, CA (US); Vishwanath Shastry, Mountain View, CA (US)

(21) Appl. No.: 13/089,231

(22) Filed: Apr. 18, 2011

Related U.S. Application Data
(60) Provisional application No. 61/325,809, filed on Apr. 19, 2010.
(60) Provisional application No. 61/356,981, filed on Jun. 21, 2010.

(51) Int. Cl. G06Q 40/00

(52) U.S. Cl. 705/39; 705/35

(57) ABSTRACT

A method for a value transfer operation includes determining a sender currency using the account information of the sender and a receiver currency using the BIN associated with the sender account. The method further includes determining a currency exchange rate, transaction fee, and currency markup fee based on the sender and receiver currencies and various attributes of the sender account and the receiver account.

### CROSS-REFERENCES TO RELATED APPLICATIONS

The present application claims benefit under 35 U.S.C. §119(e) of U.S. Provisional Patent Application No. 61/325,809, entitled “Alias Management for Value Transfer”, filed Apr. 19, 2010, and U.S. Provisional Application No. 61/356,981, entitled “Value Money Transfer Calculation of Fees and Foreign Exchange Rates”, filed on Jun. 21, 2010, the contents of which are hereby incorporated by reference in their entirety for all purposes.

The present application is related to commonly-owned U.S. patent application Ser. No. 13/034,449 filed on Feb. 24, 2011, and U.S. patent application Ser. No. ______. filed on ______, (Attorney Docket #79900-791989) the contents of which are incorporated herein in its entirety for all purposes.

### BACKGROUND

In a traditional cross-border payment card transaction, a consumer presents a his payment card (e.g., a credit card) to a merchant for payment. The consumer's payment card may be issued by an issuer in country A that uses currency A while the merchant may be located in country B with currency B. After the payment card is presented to the merchant, the consumer is presented with a receipt that shows the payment amount in local currency B of the merchant. After the merchant's acquirer presents the payment for settlement, a payment processing network calculates the foreign exchange rate between currency A and currency B and an equivalent amount of money in currency A is debited from the consumer's account.

In a dynamic currency conversion scenario, when a consumer presents his payment card to a merchant, the merchant can offer a choice to the consumer as to which currency the consumer wants to conduct the transaction. For example, the consumer's payment card currency may be US Dollar (USD) and the merchant's currency may be Euro. In this situation, if the consumer chooses USD to complete the transaction, the merchant bears the risk of currency exchange conversion. In such an instance, the merchant may charge an additional amount to offset the currency exchange risk. In dynamic currency conversion, the consumer often ends up paying more since the merchant usually presents the transaction for conversion when it is most advantageous from the merchant's perspective.

In a traditional money transfer scenario, the sender usually specifies a destination country and a receiver's destination currency to the institution performing the money transfer. For example, “send 500 Euros to Person A in Germany”. In this instance, the sending institution informs the user an equivalent amount of money in sender's home currency needed to perform the value transfer. In another traditional approach, the sender may specify “please send $1000 worth of Pesos to person A's account” and provide the sending institution with the account number. Thus, in a traditional scenario there is no need fort he sending institution to determine the destination currency as it is usually provided by the sender.

### SUMMARY

Embodiments of the present invention generally relate to value transfer transactions. Specifically, certain embodiments of the present invention provide a method for determining currency and currency exchange rates for a money transfer transaction based on account information of the sending party and the account information of the receiving party. Value transfer generally relates to any transfer that involves an item of value. Money transfer is a form of value transfer. Although money transfer is used in the following description to explain the various embodiments, it is to be understood that any other type of value transfer can be accomplished using one or more embodiments discussed below.

In some embodiments, a method for performing a value transfer transaction is provided. The method includes receiving a first account identifier associated with a first account of a sending party and receiving transaction details of the value transfer transaction that includes at least an amount of money being transferred. The method further includes receiving information about a second account of a receiving party in the value transfer transaction including a second account identifier for the second account, analyzing the first account identifier to determine a first currency associated with the first account and using the second account identifier to determine a second currency associated with the second account, determining an exchange rate between the first currency and the second currency, applying the exchange rate to the value transfer transaction to determine a total amount payable by the sending party, presenting the total amount to the sending party for approval, and performing transfer of money from the first account to the second account if the sending party approves the value transfer.

The method may further include calculating a currency exchange markup value and debiting the first account with money equal to the markup value and determining fees for the value transfer transaction based on one or more attributes associated with the first account and/or the second account. In some embodiments, the one or more attributes may include type of account, the first currency, the second currency, a first country associated with the first account, a second country associated with the second account, status of the first account, relationship between an issuer of the first account and issuer of the second account, or status of the second account. The method may further include determining a risk score for the value transfer transaction and determining a transaction fee based at least in part on the risk score. In addition, the method may also include performing anti money laundering screening for the sending party and/or the receiving party, and suggesting an action to be performed based on the screening.

In other embodiments, a payment processing network server is provided. The payment processing network server includes a processor, a memory coupled to the processor and including a data store, and a rules engine coupled to the processor. In some embodiments, the processor may receive an account identifier for a first account associated with a sending entity in a money transfer transaction and account information for a second account associated with a receiving entity in the money transfer transaction. In an embodiment, the account information for the second account may include a bank identification number (BIN). The processor may further determine a first currency associated with the first account using the account number for the first account, determine a second currency associated with the second account using the BIN for the second account, determine a currency exchange rate between the first currency and the second currency, determine a currency markup charge based on the first currency and the second currency, apply the currency markup charge to the money transfer transaction, determine a total amount payable by the sending entity including the currency markup charge, and present the total amount to the sending entity for approval. Thereafter, the processor may receive input from the sending entity indicative of approval or denial of the total amount and debit the first account for the total amount if the input indicates that the sending entity has approved the total amount.

In some embodiments, the processor may calculate a fee associated with the money transfer transaction based on one or more attributes related to the money transfer transaction. The one or more attributes related to the money transfer transaction can include the first account, the second account, amount of money being transferred, the first currency, the second currency, originating country, relationship between the first account and the second account, or destination country. In some embodiments, the processor may also determine a transaction fee based on one or more attributes of the first account, wherein the one or more attributes of the first account comprises at least one of a type of account and account history. In an embodiment, the processor may determine a risk score for the money transfer transaction and determine a transaction fee based on the risk score.

In some embodiments, the rules engine may include one or more rules that govern a value transfer transaction. The one or more rules may include a first rule defining a maximum amount of money that can be transferred in a single transaction, a second rule defining number of money transfer transactions permitted to originate from the first account during a first specified duration, and a third rule defining number of incoming money transfer transactions permitted for the second account during a second specified duration. In some embodiments, the rules may be defined by a sending financial institution associated with the first account or a receiving financial institution associated with the second account.

Some embodiments of the present invention provide a non-transitory computer-readable medium that stores instructions which when executed by a processor in a payment processing server, causes the processor to perform a method for conducting a money transfer transaction. The method may include receiving a first account identifier associated with a first account of a sending party, receiving transaction details of the money transfer transaction that includes at least an amount of money being transferred, receiving information about a second account of a receiving party that includes a second account identifier associated with the second account, analyzing the first account identifier associated with the first account to determine a first currency associated with the first account, determining a second currency associated with the second account based on the second account identifier, determining a currency exchange rate between the first currency and the second currency, and performing transfer of money from the first account to the second account based on the transaction details.

The method performed by the processor may further include determining a currency exchange markup amount based on the first currency and the second currency, determining a total amount payable by the sending party including the currency exchange markup amount, providing the total amount to the sending entity, receiving approval of the total amount from the sending entity, and debiting the first account with money equal to the total amount. The method may further include determining a product type for the money transfer transaction and account type of the first account, determining a transaction fee based at least in part on the product type and the account type of the first account, performing an anti money laundering screening process using information about the sending party and the receiving party and generating a risk score using information about the sending party and the receiving party. In some embodiments, the risk score is provided to a receiving financial institution associated with the second account.

The following detailed description, together with the accompanying drawings will provide a better understanding of the nature and advantages of the present invention.

### BRIEF DESCRIPTION OF THE DRAWINGS

FIG. 1 is a block diagram of a system for performing a value transfer transaction according to an embodiment of the present invention.

FIG. 2 illustrates a table that may be included in a customer database according to an embodiment of the present invention.

FIG. 3 illustrates a table including association information between bank identification numbers and associated currency according to an embodiment of the present invention.

FIG. 4 is a functional block diagram of a payment processing network server according to an embodiment of the present invention.

FIG. 5 is a flow diagram of a process for a value transfer operation according to an embodiment of the present invention.

FIG. 6 is a flow diagram of a process for determining fees and markups for a value transfer operation according to an embodiment of the present invention.

FIG. 7 is a flow diagram of a process for conducting a value transfer operation according to an embodiment of the present invention.

FIGS. 8A and 8B illustrate a flow diagram of a process for performing a value transfer transaction according to an embodiment of the present invention.

FIG. 9 is a high level block diagram of a computer system.

### DETAILED DESCRIPTION

Embodiments of the present invention are generally related to value transfer transactions. Particularly, some embodiments of the present invention provide methods and systems for performing cross-border money transfers. Some embodiments of the present invention relate to a system and method for calculating money transfer fees, cross-border exchange rates, and markup rates for direct and “off-us” transfers.

In some embodiments, a method of performing cross border value transfer is provided. The method includes receiving account information for a sender and a receiver and determining a currency for the receiver based on the receiver account information. Thereafter, the method includes determining an exchange rate between the sender currency and the receiver currency, applying any currency exchange mark-up fees, if applicable, applying any other associated fees, and presenting the total amount including the fees to the sender. If the sender approves, the value transfer is processed.

In some embodiments, a cross-border fee, foreign exchange rate, and markup rates may be applied to the cross-border value transfer transaction. Fees and exchange rates may first be defined on a per level basis, where the levels are defined by individual products, payment type (direct or “off-us”), or a default. Further, within each level, specific rates and fees may be applied based on cross-border corridor promotions, cross-border promotions, cross-border corridor general rates, and a general cross border rate. The specific rates and fees are applied to the cross-border transaction.

If the currencies for the sender and receiver are the same, then domestic fees may be determined. These fees may be determined by determining the applicable level, as defined by individual products, payment type (direct or “off-us”), or a default and then determining, within each domestic level, if there is a promotional fee or a domestic fee. If no such fees exist, then no fees are applied to the transaction.

In some embodiments, during the process of determining the fees and foreign exchange rates, the money transfer system may also implement specific fraud limitations, such as domestic/cross-border value and velocity limitations, anti-money laundering screening and other security checks.

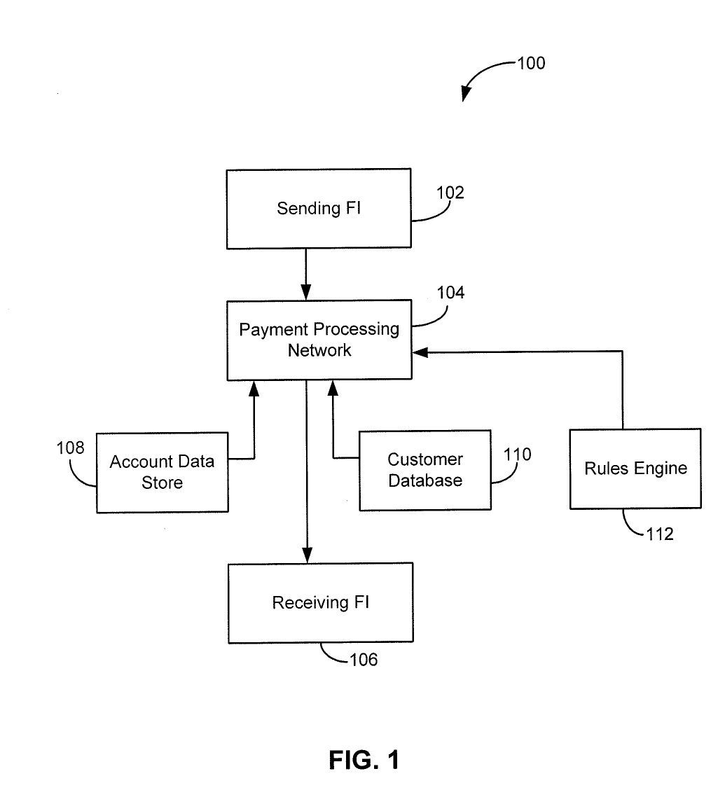

FIG. 1 is a block diagram of a value transfer system 100 according to an embodiment of the present invention. System 100 includes a sending financial institution 102, a payment processing network 104, a receiving financial institution 106, an account data store 108, a customer database 110, and a rules engine 112.

Sending financial institution 102 can be any entity with the capability to initiate a value transfer operation, e.g., a bank, a money transfer facility like MoneyGram®, or any other entity authorized to transfer value. Sending financial institution 102 may receive information related to the value transfer operation from a sender. In some embodiments, the information may include the sender's name and contact information, sender's account information, a receiver's name and contact information, and receiver account information. Sending financial institution 102 may communicate the information related to the value transfer transaction to payment processing network 104. The sending financial institution 102 may operate a server computer to facilitate the functions of the sending financial institution.

Payment processing network 104 can be any entity that can perform payment authorization and processing operation, e.g., VisaNet. The payment processing network 104 may be further configured to process credit and debit card transactions, and may perform authorization and settlement processes. Authorization processes may involve the sending of authorization request messages (which may include a primary account number, service code, transaction amount, card verification values, etc.).

In some embodiments, payment processing network 104 may receive sender and receiver account information from sending financial institution 102 and verify that the account information is authentic. In some embodiments, payment processing network 104 may communicate with an issuer associated with sender's account to process and authorize the amount that the sender wishes to transfer. In some embodiments, payment processing network 104 may communicate with account data store 108 and customer database 110 to verify the sender and sender account information. In other embodiments, payment processing network 104 may consult account data store 108 and customer database 110 to determine a currency associated with sender's account and currency associated with the receiver's account. In some embodiments, payment processing network 104 may consult rules engine 112 to determine any fees and markups to be assessed for the value transfer transaction. Once payment processing network 104 authenticates the sender and calculates the associated fees and markups, the final payment amount including the fees and markups may be provided to the sender. Upon sender approval, a payment message may be sent by payment processing network 104 to receiving financial institution 106.

Receiving financial institution 106 can be any entity with the capability to process and incoming value transfer transaction. Receiving financial institution 106 can be a bank, a money transfer facility like MoneyGram®, or any other entity authorized to process value transfer transactions. In some embodiments, receiving financial institution 106 may receive the payment authorization message from payment processing network 104, process the payment authorization message, and credit the receiver's account, in sender's currency, with an amount that is equivalent to the value being transferred.

As discussed above, payment processing network 104 can consult account data store 108 to determine the currency associated with an account. This currency information can be used in calculating currency exchange rates, any applicable currency mark-ups, etc. Usually, a sender's origination country is a good indication of the currency that may be associated with a sender's account. The same is usually true for a receiver. However, increasingly financial institutions service accounts that are in a currency different from the local currency where the financial institution is located. This is especially true for global banks such as Citigroup, etc. For example, Citigroup may have a bank location in India, but may service local accounts that have US Dollar as the billing currency of the account. In such instances, the location of the receiver in an of itself is not a good indication of the currency associated with the receiver's account.

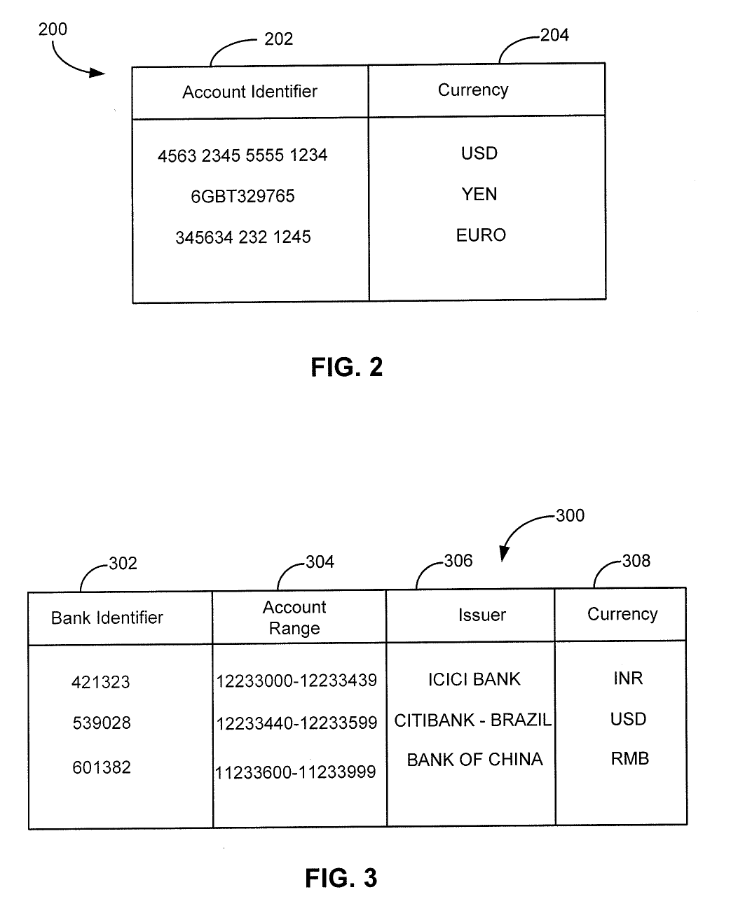

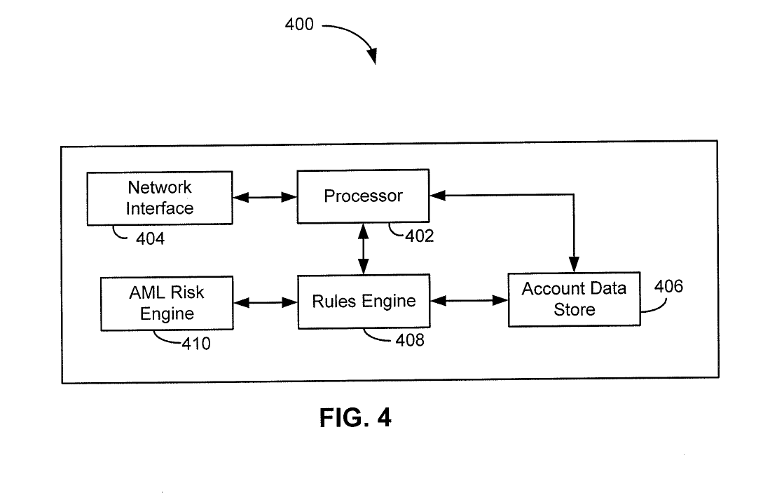

FIGS. 2 and 3 illustrate information in an account data store, e.g., account data store 108 of FIG. 1, according to an embodiment of the present invention. As illustrated in FIG. 2, the account data store may include information mapping sender account information to the associated currency. Table 200 includes account identifiers 202 that list one or more account identifiers associated with a sender accounts. For example, account identifiers 202 may be a personal account number (PAN) associated with a sender account. In other embodiments, account identifier 202 may include alphanumeric characters or any other suitable account identifier components. Table 200 may also include currency identifiers 204 associated with each account identifier 202. Currency identifiers 204 may provide information about the currency associated with the sender account. In some embodiments, currency identifiers 204 may include the internationally recognized acronyms/abbreviations for a currency, e.g., USD, EURO, INR, etc. In other embodiments, currency identifiers 204 may include the symbol associated with a currency, e.g., $, [symbol] , ¥.

FIG. 3 shows a table 300 that includes account information for a receiver according to an embodiment of the present invention. Table 300 includes bank identifier 302, account range identifier 304, issuer name 306, and currency identifier 308.

Bank identifier 302 can include a bank identification number (BIN) associated with the receiver's account. Bank identification number or BIN is usually the first six digits of a bank card number, e.g., a credit card number. BIN may help to identify the financial institution that issued a particular bank card such as a credit card, a debit card, or the like. Each financial institution may have one or more BINs associated with it.

Account range identifier 304 can be associated with a particular BIN. Each BIN can include multiple account ranges. Each account range in a particular BIN can have one or more attributes associated with it. The one or more attributes may include the currency associated with the account, type of account, etc. If there are more than one account ranges associated with a particular BIN, each account range for that BIN may have a different currency associated with it. For example, consider BIN 539028 for Citibank Brazil. There can be multiple account ranges associated with this BIN. One account range is illustrated in FIG. 3. The illustrated account range may have USD as it currency, which means all accounts in that account range have USD as their operating currency. A different account range, e.g., 12233110-12233210, associated with the same BIN may have the Brazilian Real as the operating currency. Thus, it may be possible use the account range associated with a BIN to determine a currency associated with that account. The account ranges are mapped to the individual PANs. In some embodiments, account range identifier 304 can include numbers or alphanumeric characters.

Issuer 306 may include name of the financial institution associated with the corresponding BIN 302. Issuer 306 can be any suitable institution that can issue an account. Issuers can also issue portable consumer devices (e.g., payment cards) associated with such accounts.

Currency identifier 308 can be associated with the receiver's account, e.g., account range identifier 304. Currency identifier 308 may include information about the currency associated with a particular account number. In some embodiments, currency identifier 308 may include the internationally recognized acronyms/abbreviations for a currency, e.g., USD, EURO, INR, etc. In other embodiments, currency identifier may include the symbol associated with a currency, e.g., $, [symbol] , ¥. In operation, the payment processing network server can use table 300 to determine the receiver's account number, bank name, and currency using the account identifier. Once the receiver currency is determined, the payment processing network can determine the exchange rate between the sender currency and the receiver currency and any applicable fees.

As discussed above, the payment processing network may receive the information about the sender and the receiver from the sending financial institution. Based on this information, the payment processing network may authenticate the sender and authorize the payment amount with the issuer for the sender and determines the currency of the sender, e.g., using table 200. The payment processing network server computer may then use the receiver account identifier, account number provided by the sender, and associated account range, e.g., by consulting table 300, to determine receiving financial institution and the currency associated with the receiver account. Once the sender currency and the receiver currency are determined, the payment processing network may determine the currency exchange rate and any applicable fees and markups to be assessed for the value transfer operation.

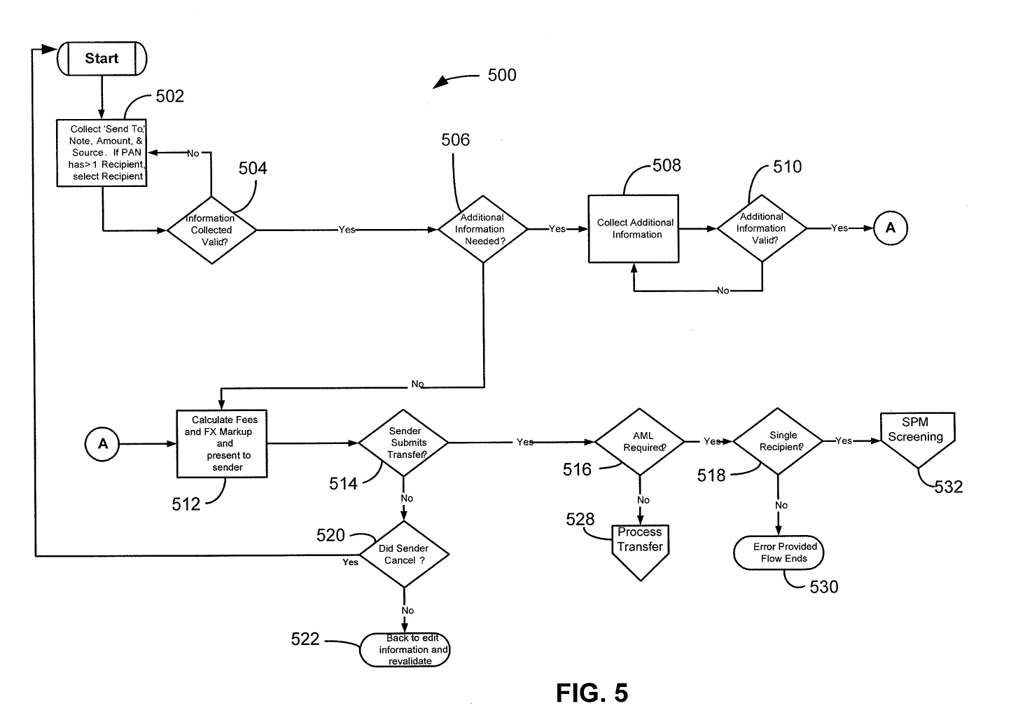

FIG. 4 is a functional block diagram of a server computer 400 that can be present in the payment processing network according to an embodiment of the present invention. Server computer 400 includes a processor 402, network interface 404, account database 406, rules engine 408, and anti-money laundering risk screening engine 410.

Processor 402 may be implemented using one or more integrated circuits and can be configured to control the operation of server computer 400. For example, processor 402 can receive information about the receiver's account and determine a currency associated with the receiver's account based on the account information.

Network interface 404 allows server computer 400 to communicate with one or more external systems such as a sending financial institution, a receiving financial institution, etc. In some embodiments, network interface 404 can include wireless transceiver components for accessing wireless networks. In some embodiments, network interface 404 can provide wired network connectivity (e.g., Ethernet) in addition to or instead of a wireless interface. Network interface 404 can be implemented using a combination of hardware (e.g., antennas, modulators/demodulators, encoders/decoders, and other analog and/or digital signal processing circuits) and software components.

Account database 406 can be implemented e.g., using disk, flash memory, or any other nonvolatile storage medium. In some embodiments, account database 406 can include one more databases. For example, account data store 406 can include an account data store (e.g., account database 108 of FIG. 1) and/or a customer database (e.g., customer database 110 of FIG. 1). In some embodiments, account data store 406 may include information in tables 200 and 300 described above.

Rules engine 408 may include one or more rules that are applicable to a value transfer operation. The one or more rules may be defined by the sending financial institution, the receiving financial institution, and/or the payment processing network. For example, rules engine 408 may include rules that define criteria for assessing fees related to a cross-border value transfer operation. In an embodiment, rules engine 408 may include a rule that defines how much markup is to be charged for a particular money transfer operation based on the sender currency and the receiver currency. Several rules may be defined for a value transfer operation as described below. It is to be noted that the list of rules described below is meant to be representative only and is not exhaustive. Other rules in addition to or in lieu of the rules described below may be defined for a value transfer operation.

A first rule may be defined based on whether the value transfer is domestic or cross-border. For example, no fees or markups may be charged for a domestic transfer while a cross-border transfer may be assessed a certain fee.

A second rule may be defined based on the type of sender account. For example, an individual account may be charged a higher fee than a corporate account. A third rule may be defined for the type of payment transaction, e.g., On-Us or Off-Us. An On-Us transaction is the one in which the sender has an account at the sending financial institution where the transfer is originated. For example, a sender has a payment device (e.g., a credit card) issued by Citibank and the sender initiates a money transfer transaction using that payment device at a Citibank branch or a Citibank ATM. In contrast, an Off-Us transaction is the one in which the sender does not have any account at the sending financial institution where the transfer is originated.

A fourth rule may be defined based on the sender currency and the receiver currency. For example, a higher fee may be charged for currencies that are known to be less stable while a lower fee may be assessed for currencies that are known to be stable. The rule may also be based on a combination of the sender currency and the receiver currency and the history of exchange rates between the currencies. For example, if the sender currency is USD and the receiver currency is that of a poor nation and if the currency exchange rate between these currencies is known to vary widely, a higher fee may be assessed to insure against such currency fluctuation.

A fifth rule may be defined based on the country of origination and/or destination of the value transfer operation. For example, if a value transfer operation is to a receiver in a developing country with a highly volatile currency, a higher fee/mark up may be charged compared to if the destination country is a developed country with a stable currency. A sixth rule may be defined based on the sender account attributes and/or receiver account attributes. Account attributes can include duration of account existence, past history of transfers using the account, payment history for the account, etc. It is to be noted that the attributes mentioned here are illustrative only. One skilled in the art will realize that there are many more attributes of an account that can be used to define the rules. For example, if an account is in good standing and has had several successful value transfer operations conducted using the account; a first fee may be charged for a value transfer operation using that account. On the other hand if an account is not in good standing, a second fee higher that the first fee may be charged to insure against the risk of a value transfer operation using that account.

It is to be noted that the rules described above are exemplary and not meant to be an exhaustive. Many more rules in addition to or in lieu of the above-described rules may be defined by the sending financial institution, the receiving financial institution, and/or the payment processing network.

Anti-money laundering (AML) risk engine 410 may screen the sender information and/or the receiver information to determine the possibility of money laundering. AML risk engine may include rules and criteria for evaluating a value transfer operation for potential money laundering activities. Details of screening for money laundering are provided in a commonly owned and co-pending U.S. patent application Ser. No. ______ filed on ______, (Attorney Docket #016222-068520US) and 61/330,283, filed on Apr. 30, 2010 (Attorney Docket#016222-068500US) the contents of which are incorporated by reference herein in their entirety for all purposes.

Further, while server computer 400 is described herein with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of devices including electronic devices implemented using any combination of circuitry and software.

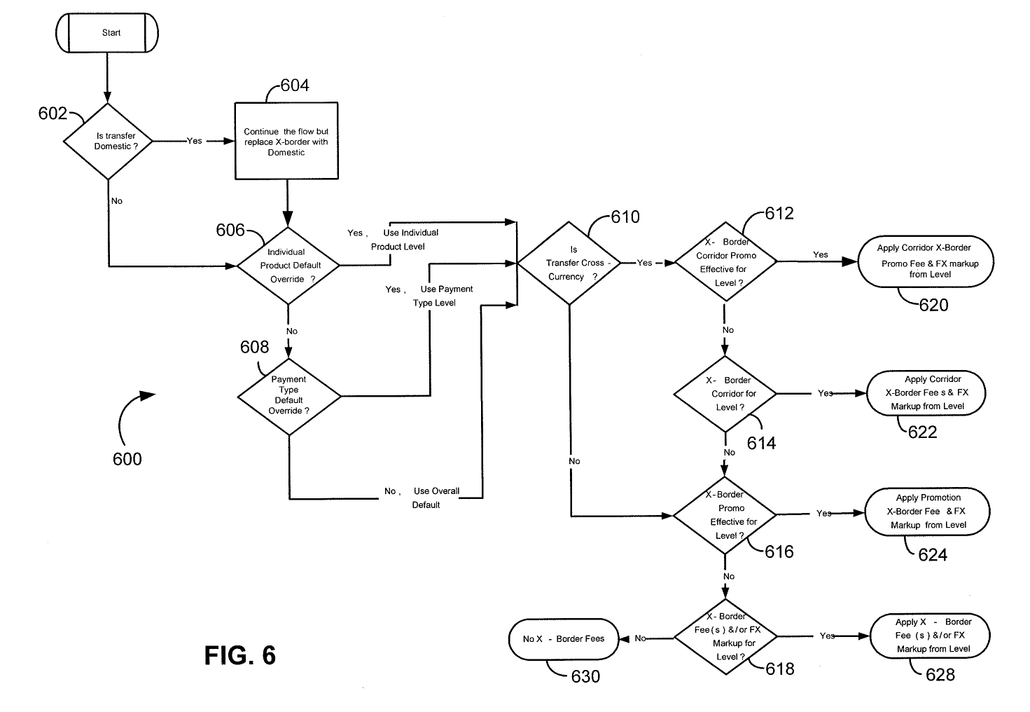

FIG. 5 is a flow diagram of a process 500 for a value transfer operation according to an embodiment of the present invention. Process 500 may be performed, e.g., by payment processing network server 400 of FIG. 4. Reference can also be made to the system diagram of FIG. 4.

Process 500 starts at step 502 where the sender may provide details of the value transfer operation to a sending financial institution 102, which in turn may communicate the details to a payment processing network 104. The details of the value transfer operation may include sender account information, receiver account information, amount of money transfer, sender alias, receiver alias, etc. “Alias” in this context refers to a unique identifier associated with the sender or the recipient, e.g., an email address or a passphrase. After receiving the details, they may be checked for validity at step 504 by a server computer in the payment processing network 104. In some embodiments, validation may include checking the user account information, e.g., using information in the customer database 106 of FIG. 1. The server computer in the payment processing network 104 may also search for the receiver information to determine if the receiver account information is valid, e.g., whether receiver PAN exists in the account data store 108 of FIG. 1. Many other validation checks may also be made. If the validation fails, process 500 returns to step 502 where the sender is requested to provide the correct information. If the validation is successful, the server computer may determine whether any additional information is needed for processing the value transfer request (step 506). In some embodiments, additional information may include additional sender identifiers, e.g., date of birth of receiver and/or sender, expiry date for the PAN of the receiver or the sender, card verification value 2 (CVV2) for the PAN of the receover or sender, etc. or additional recipient identifiers, e.g., billing address or country of residence.

If additional information is needed, the additional information may be received at step 508 and may be checked for validity. If the additional information is determined to be valid (step 510) by the server computer, process 500 may continue to step 512. If the additional information is not valid, process 500 returns to step 508. On the other hand, if it is determined at step 506 that additional information is not needed, process 500 may continue directly to step 512.

At step 512, the server computer in the payment processing network 104 may determine the fees and markups to be applied to the value transfer transaction. For example, the server computer may determine the currency of the sender and the currency of the receiver, e.g., using receiver BIN of table 300, and may determine an exchange rate between the two currencies. Based on the exchange rate and one or more rules described above, the server may determine the fees and/or currency markup to be applied to the value transfer transaction. After the fees and/or mark-ups are determined, a total amount payable by the sender may be calculated and provided to the sender for approval. At step 514 a determination may be made whether the sender has approved or denied the total amount for the value transfer transaction based on sender input received. If the sender approves the total amount, the server may determine whether the value transfer transaction is to be screened for anti-money laundering (AML) at step 516. If it is determined that an AML screening is to be performed, the server may check if the recipient of the value transfer transaction is a single receiver at step 518. If the recipient is a single receiver, the details of the value transfer transaction may be sent to an anti-money laundering screening system at step 532. If the there are multiple recipients, an error message may be generated at step 530 and process 500 may end. If it is determined at step 516 that AML screening is not required, process 500 may continue to step 528.

Going back to step 514, if it is determined that the sender has not approved the value transfer, a check may be made to determine whether the sender has canceled the value transfer (520). If it is determined that the sender has canceled the value transfer, process 500 may return to step 502. If it is determined that sender has not canceled the value transfer, the server computer may perform a revalidation of the information entered or provide the sender with an opportunity to resubmit the information (522).

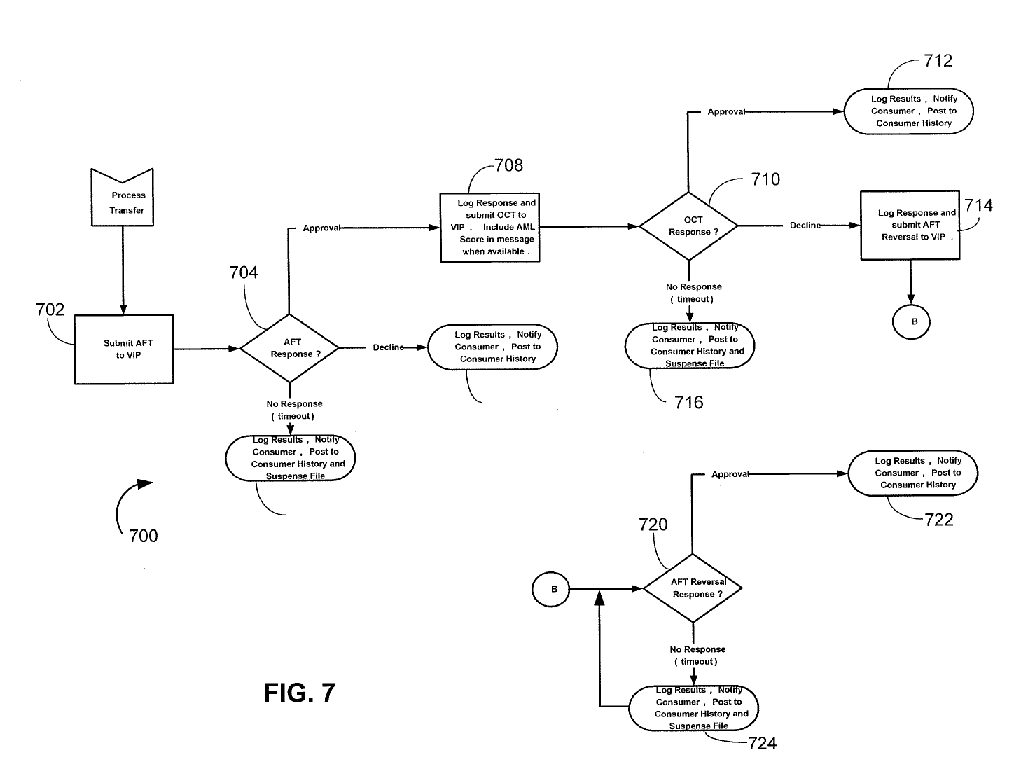

As described above, based on the information provided by the sender, a determination can be made about the fees and/or markups to be assessed for a particular value transfer transaction. FIG. 6 is a flow diagram for a process 600 for determining fees and markups for a value transfer operation according to an embodiment of the present invention. Process 600 may be performed e.g., as part of step 512 of FIG. 5.

The server computer may determine whether the value transfer is domestic or cross-border (S602). Cross-border in this context means that the receiver account is at a receiving financial institution that is located in a different country than the sender. In other words, if the country code associated with the BIN of the sending financial institution is not the same as the country code associated with the receiving financial institution BIN, the transaction is considered cross-border. For example, the sender account may be at Citibank in the United States and the receiver account may be at ICICI bank Ltd. located in India. Depending on whether the transfer is domestic or cross-border a different fee/mark-up scheme may be used.

If it is determined that the transfer is domestic, process 600 may continue at step 604 using the same flow described below but using the domestic fee structure instead of the cross-border fee structure. If the transfer is cross-border, the system may determine whether to apply the fees based on the product type (S606), e.g., whether the money transfer is being requested using a credit card or a debit card. If it is determined that the fees are not be applied based on the product type, a determination may be made whether the fees are to be applied based on the type of transaction (S608), e.g., On-Us or Off-Us transaction described above. A determination may be made by the server computer as to whether the value transfer is a cross currency transfer (S610). In this context, cross currency means that the default currency associated with the sender's account is different from the default currency associated with the receiver's account. Based on whether the transfer is domestic or cross-country and whether the transfer is within same currency or cross currency, at least four different transaction types are possible. For example, the transaction can be (a) cross-border, same currency, (b) domestic, same currency, (c) cross-border, cross-currency, or (d) domestic, cross-currency.

If the transfer is between two different currencies, the system may determine whether there is any cross-border corridor promotion applicable based on either the product type or the payment type (S612). In this context, a “Promotion” means special fees and/or mark-up's that may be predefined for a particular product type and/or a payment type for a cross-currency transaction, usually for a set period of time. For example, for a specified period, a credit card transaction may have higher fees associated with it than a debit card transaction or an On-Us transaction may have lower fees than an Off-Us transaction due to the increased risk of an Off-Us transaction. A corridor is defined as a set including the country associated with the sending financial institution and the country associated with the receiving financial institution. In some embodiments, certain corridors may have promotions associated with them. For example, in some embodiments, the system may not charge any fees and/or markups for value transfers between USA and Canada or may charge reduced fees for the value transfer. Such corridor promotions can be made available for various business reasons such as encouraging value transfers to of from certain countries or regions. It is to be noted that corridor promotion is not limited to between two countries. In some embodiments, a corridor promotion may be defined for a group of countries or a region, e.g., NATO countries, countries in the African Union, etc.

If a corridor promotion is available, then that corridor promotion may be applied to the transaction (S620). If no corridor promotion is available, the server computer may determine a standard set of fees/markups to apply to the transaction based on a predefined set of rules. In other words, the server computer may determine the sender account currency and the receiver account currency, determine an exchange rate between the currencies and may also determine additional risk factors such as currency fluctuations, etc. to determine the fees and/or mark-up's to be applied (S614). The system may then apply the determined fees and/or mark-up's to the transaction (S622).

If at step 610 it is determined that the transfer is not between different currencies (i.e. the value transfer is between same currency), a determination may be made, similar to step 612, whether any cross-border promotion applies to the transaction (S616). If a cross-border promotion applies, the promotional fees and/or mark-up's may be applied to the transaction (S624). If no cross-border promotion is applicable, a determination may be made whether any standard cross-border fees and/or mark-up's are applicable to the transaction (S618) and if applicable, the associated fees and/or mark-up's may be applied to the transaction (S628). If no cross-border fees and/or mark-up's are applicable, no fees and/or mark-up's may be applied to the transfer (S630).

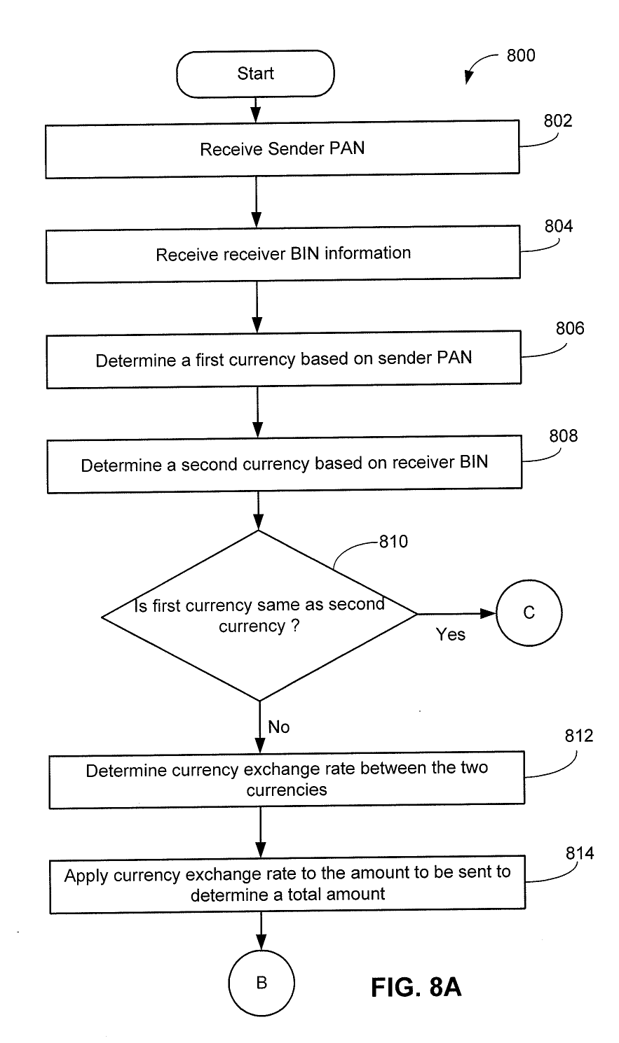

Once the sender approves the money transfer, the server computer in the payment processing network 104 may then process the transfer. FIG. 7 is a flow diagram for a process 700 for a method of processing the value transfer operation according to an embodiment of the present invention. For example, process 700 can occur as part of step 528 of FIG. 5.

Once the sender approves the value transfer transaction, the transaction is processed by, e.g., the server computer in the payment processing network 104. At step 702 the payment processing network sends a request (AFT) to the sending financial institution requesting that the amount of the value transfer (including any applicable fees or markup) be withdrawn from the sender's account in the sender's currency. The transaction details may be verified for authenticity at step 704 and approved or declined by the sending financial institution. For example, the sender account details may be verified and authenticated. If the results of the verification indicate that the transaction is authentic, the transaction may be submitted for further processing. At step 708, the payment processing network sends a request (e.g., OCT—Original Credit Transaction) to the receiving financial institution requesting that the amount of the value transfer be credited to the recipient's account in the recipient's currency. At step 710, the transaction may be processed. The transaction can either be approved at step 712 or declined at step 714 by the receiving financial institution. If the transaction cannot be processed, the transaction may time out at step 716. If the transaction is declined at step 714, the payment processing network sends a request (e.g., AFT (Automated Funds Transfer) reversal) to the sending financial institution requesting that the sum originally withdrawn from the sender's account be reversed. The reversal can be approved at step 722.

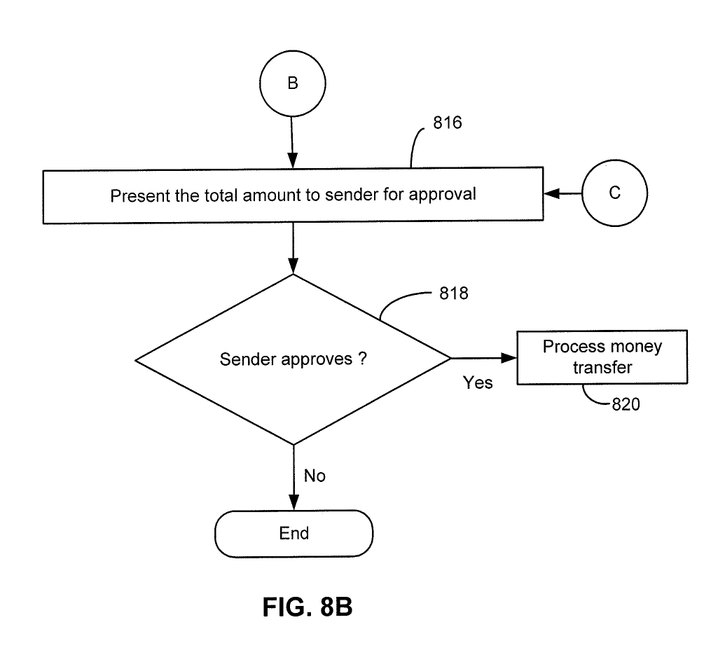

As discussed above, in an embodiment, the payment processing network may determine the currencies involved in a value transfer operation based on the account identifiers provided as part of the value transfer transaction. FIGS. 8A and 8B illustrate a flow diagram of a process 800 for performing a value transfer transaction according to an embodiment of the present invention.

At step 802, the sender provides details regarding the value transfer operation, e.g., to a sending financial institution. The details of the value transfer operation may include, name and account information of the sender, the amount of value to be transferred, name and account information of the receiver, etc. For example, the sender may provide his PAN information to the sending financial institution. At step 804, the server computer in the payment processing network may also receive the BIN information for the receiver account via the sending financial institution. At step 806, the server computer in the payment processing network may determine the sender currency based on the PAN information, e.g., using information in customer database 110 of FIG. 1 and table 200 of FIG. 2. At step 808, the server computer in the payment processing network may determine a receiver currency associated with the receiver account by using the provided BIN information, e.g., using table 300 of FIG. 3. At step 810, a determination may be made to ascertain whether the sender currency is same as the receiver currency. If the sender currency is same as the receiver currency process 800 may proceed to step 816. If the sender currency is not the same as the receiver currency, the payment processing network may determine an exchange rate between the two currencies at step 812. Based on the exchange rate between the two currencies, the payment processing network may apply the exchange rate to the value transfer transaction to calculate a total amount payable by the sender. In some embodiments, the payment processing network may also determine any applicable cross-border fees, currency exchange mark-ups, etc. and add that to the total amount payable by the sender at step 814.

At step 816, the server computer in the payment processing network may present the total amount to the sender for approval,. At step 818, the server computer in the payment processing network may check to see if the sender has approved the transaction. If the sender approves the transaction, the server computer in the payment processing network may process the value transfer transaction at step 820. If the sender does not approve the transaction, process 800 may end. In some embodiments, process 800 may return to step 802 and provide the sender an opportunity to edit some or all the details of the value transfer transaction.

It should be appreciated that the specific steps illustrated in FIGS. 5, 6, 7, and 8 provide a particular method of processing a value transfer transaction according to an embodiment of the present invention. Other sequences of steps may also be performed according to alternative embodiments. For example, alternative embodiments of the present invention may perform the steps outlined above in a different order. Moreover, the individual steps illustrated in FIGS. 5, 6, 7, and 8 may include multiple sub-steps that may be performed in various sequences as appropriate to the individual step. Furthermore, additional steps may be added or removed depending on the particular applications. One of ordinary skill in the art would recognize many variations, modifications, and alternatives.

Many advantages are realized by embodiments of the present invention. First, the transaction fees, exchange rates, and markups can be customized to provide the best possible rates to the sender and/or the receiver. For example, a sender can receive preferred rates for his value transfer transaction based on his account type and history. A user with a good account history will be able to get better exchange rate than a user with a poor account history. In other instances, a preferred account, e.g., a VISA Signature account may be charged a lower fee and no currency exchange markups compared to a regular VISA account. Second, the sender is provided with the estimated amount that he has to pay upfront by doing all the currency conversion and fee calculations upfront. The sender has the ability to approve or deny the transfer after seeing the total amount that he has to pay. This gives added flexibility to the sender and provides better transparency for the value transfer process. The system also allows greater flexibility for the sending and receiving entities to set fees and exchange rates to provide better service to their customers. In addition, the sender does not have to specify the currency of the receiver. The system can automatically determine the receiver currency using the account information of the receiver. This greatly simplifies the value transfer process since the sender may not know the receiver currency.

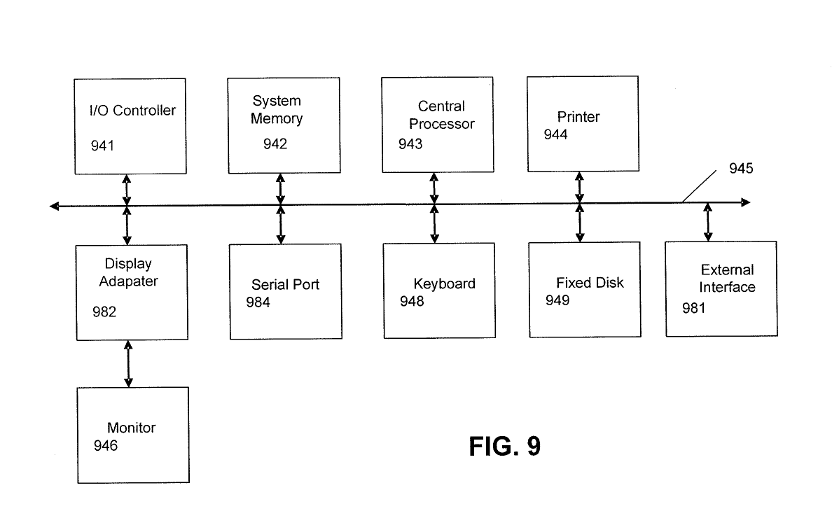

FIG. 9 is a high level block diagram of a computer system that may be used to implement any of the systems and/or individual components described above in relation to FIGS. 1 and 4 and may include one or more of the subsystems or components shown in FIG. 9, which is a block diagram of a computer apparatus. The subsystems shown in FIG. 9 are interconnected via a system bus 945. Additional subsystems such as printer 944, keyboard 948, fixed disk 949, monitor 946, which is coupled to display adapter 982, and others are shown. Peripherals and input/output (I/O) devices, which couple to I/O controller 941, can be connected to the computer system by any number of means known in the art, such as serial port 984. For example, serial port 984 or external interface 981 can be used to connect the computer apparatus to a wide area network such as the Internet, a mouse input device, or a scanner. The interconnection via system bus 945 allows central processor 943 to communicate with each subsystem and to control the execution of instructions from system memory 942 or fixed disk 949, as well as the exchange of information between subsystems. The system memory 942 and/or fixed disk 949 may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Thus, although the invention has been described with respect to specific embodiments, it will be appreciated that the invention is intended to cover all modifications and equivalents within the scope of the following claims.

What is claimed is:

1. A payment processing network server comprising:
a processor;
a memory coupled to the processor, the memory including a data store; and
a rules engine coupled to the processor;
wherein the processor is configured to:
receive a first account identifier for a first account associated with a sending entity in a money transfer transaction;
receive account information for a second account associated with a receiving entity in the money transfer transaction, the account information for the second account including a second account identifier;
determine a first currency associated with the first account using the first account identifier;
determine a second currency associated with the second account using the second account identifier;
determine a currency exchange rate between the first currency and the second currency;
determine a currency markup charge based on the first currency and the second currency;
apply the currency markup charge to the money transfer transaction;
determine a total amount payable by the sending entity, the total amount including the currency markup charge;
present the total amount to the sending entity for approval;
receive input from the sending entity, the input indicative of approval or denial of the total amount; and
debit the first account for the total amount, if the input indicates that the sending entity has approved the total amount.

2. The payment processing network server of claim 1 wherein the processor is further configured to calculate a fee associated with the money transfer transaction based on one or more attributes related to the money transfer transaction.

3. The payment processing network server of claim 2 wherein the one or more attributes of the money transfer transaction comprise the first account, the second account, amount of money being transferred, the first currency, the second currency, originating country, or destination country.

4. The payment processing network server of claim 1 wherein the processor is further configured to determine a transaction fee based on one or more attributes of the first account, wherein the one or more attributes of the first account comprises at least one of a type of account and account history.

5. The payment processing network server of claim 1 wherein the processor is further configured to:
determine a risk score for the money transfer transaction; and
determine a transaction fee based on the risk score.

6. The payment processing network server of claim 1 wherein the rules engine comprises one or more rules that include:
a first rule defining a maximum amount of money that can be transferred in a single transaction;
a second rule defining number of outgoing money transfer transactions permitted for the first account during a first specified duration; and
a third rule defining number of incoming money transfer transactions permitted for the second account during a second specified duration.

7. The payment processing network server of claim 6 wherein the one or more rules are defined either by a sending financial institution associated with the first account or a receiving financial institution associated with the second account.

8. A method comprising, by a payment processing network server:
receiving a first account identifier associated with a first account of a sending party in a value transfer transaction;
receiving transaction details of the value transfer transaction, wherein the transaction details include at least an amount of money being transferred;
receiving information about a second account of a receiving party in the value transfer transaction;
analyzing the first account identifier associated with the first account to determine a first currency associated with the first account;
determining a second account identifier associated with the second account;
analyzing the second account identifier for the second account to determine a second currency associated with the second account;
determining an exchange rate between the first currency and the second currency;
applying the exchange rate to the value transfer transaction to determine a total amount payable by the sending party;
presenting the total amount to the sending party for approval; and
performing transfer of money from the first account to the second account if the sending party approves the value transfer.

9. The method of claim 8 wherein the first account identifier comprises a personal account number (PAN) associated with the first account.

10. The method of claim 8 wherein the second account identifier comprises a bank identification number, an account number, address for the receiving party, or name of the receiving party.

11. The method of claim 8 further comprising determining fees for the value transfer transaction, the fees being based on one or more attributes associated with the first account and/or the second account.

12. The method of claim 11 wherein the one or more attributes comprise type of account, the first currency, the second currency, a first country associated with the first account, a second country associated with the second account, status of the first account, or status of the second account.

13. The method of claim 8 further comprising determining a risk score for the value transfer transaction and determining a transaction fee based at least in part on the risk score.

14. The method of claim 8 further comprising:
performing anti money laundering screening for the sending party and/or the receiving party; and
suggesting an action to be performed based on the screening.

15. A non-transitory computer-readable medium storing instructions which when executed by a processor in a payment processing server computer, cause the processor to perform a method comprising:
receiving a first account identifier associated with a first account of a sending party in a money transfer transaction;
receiving transaction details of the money transfer transaction, wherein the transaction details include at least an amount of money being transferred;
receiving information about a second account of a receiving party in the money transfer transaction, the information including a second account identifier associated with the second account;
determining a first currency associated with the first account using the first account identifier;
determining a second currency associated with the second account using the second account identifier;
determining a currency exchange rate between the first currency and the second currency;
determining a total amount to be debited from the first account based on the currency exchange rate; and
performing transfer of the amount of money specified in the transaction details to the second account, wherein the amount of money deposited in the second account is of the second currency.

16. The computer-readable medium of claim 15 wherein the method further comprises:
determining a currency exchange markup amount based on the first currency and the second currency;
determining the total amount payable by the sending party, the total amount including the currency exchange markup amount;
providing the total amount to the sending entity;
receiving approval of the total amount from the sending entity; and
debiting the first account with money equal to the total amount.

17. The computer-readable medium of claim 15 wherein the method further comprises determining a product type for the money transfer transaction and account type of the first account.

18. The computer-readable medium of claim 17 wherein the method further comprises determining a transaction fee based at least in part on the product type and the account type of the first account.

19. The computer-readable medium of claim 15 wherein the method further comprises determining a risk score for the money transfer transaction and suggesting an action based on the risk score.

20. The computer-readable medium of claim 19 wherein the risk score is generated by performing an anti money laundering screening process using information about the sending party and the receiving party.
